(19) United States
(12) Patent Application Publication
(10) Pub. No.: US 2003/0182854 A1
(43) Pub. Date: Oct. 2, 2003

(54) Method for sowing seeds

(76) Inventor: Matti Reinikainen, Lahti (FI)

Correspondence Address: Daniel D Fetterley, Andrus Sceales Starke & Sawall, Suite 1100, 100 East Wisconsin Avenue, Milwaukee, WI, 53202-4178, US

(21) Appl. No.: 10/258,674

(22) PCT Filed: Apr. 25, 2001
(86) PCT No.: PCT/FI01/00399

(30) Foreign Application Priority Data
Apr. 25, 2000 (FI) 2000967

(51) Int. Cl. A01C 1/06; A01C 21/00

(52) U.S. Cl. 47/57.6

(57) ABSTRACT

The invention relates to a method for the sowing of seeds, in which method the seeds are inoculated with a desired microbial population intended for a land area to be regenerated, restored and/or landscaped and the inoculated seeds are sown. The desired microbial population substantially corresponds to the microbial population of the future seeding site of the seeds. The invention also relates to a seeding substrate used in the method.

The present invention relates to a method for the sowing of seeds as defined in the preamble of claim 1 and to a seeding substrate as defined in the preamble of claim 11.

Land areas such as forests and other areas to be restored and landscaped are regenerated either naturally or by cultivating, i.e. by sowing seeds or planting seedlings. In regeneration and/or restoration via cultivation, seeds are sown and/or seedlings are planted in the regeneration area after felling and harvesting of wood. In current cultivation methods, plowing, harrowing, scarifying or mounding are used to create good conditions, for germination and growth of seeds and seedlings.

A problem with prior-art methods is that the regeneration and/or restoration performed after felling and/or harvesting is a separate operation requiring separate labor and time. In addition, known methods require tillage that breaks up the land area. The tillage methods further accelerate grass growth in the area. Moreover, these methods normally erode the thermal insulation layer on the ground surface, e.g. moss and mor, with the result that especially frost after rain produces an ice rind effect destructive to seedlings.

On the other hand, there is the problem that in untilled soil the germination and growth of seeds is slow and a proportion of the seeds is never activated into growth. For this reason, to guarantee a sufficient seedling density, the seeding has to be performed using a seed density multiple times higher than the theoretical density.

A further problem is the adaptation of seeds/seedlings to the land area being treated. A seed/seedling that is unaccustomed to the microbial population of the land area in question or whose microbial population differs from that of the land area requires a long adaptation time, which retards the start of growth or even stops it altogether. The waste of seeds/seedlings has a great economic significance.

In addition, active. utilization of forests and/or other areas has resulted in a reduction of diversity as certain wood species. and types of natural environment have been favored at the expense of others.

Moreover, the regeneration results obtained by present-day cultivation methods are not natural in respect of landscape and/or ecology.

The object of the present invention is to eliminate the above-mentioned disadvantages.

A specific object oft the invention is to disclose a, method whereby the seeds to be sown are prepared for the environment of the seeding site by infecting them with a desired., microbial population in order to modify the microbial population of the seeding site.

A further object of the invention is to disclose a method for the regeneration, restoration and/or landscaping of a land area while maintaining and/or increasing its bio-diversity. A specific object of the invention is to disclose a method for the regeneration and restoration of woods into a natural, special and/or park wood condition.

Yet another object of the invention is to disclose a method which yields a natural result and in which the seeds are sown in a manner saving labor, time and seeds and without tilling or stressing.. the land area in connection with the felling and/or harvesting of wood.

An additional object of the invention is to disclose a seeding substrate for implementing the method.

The method of the invention is characterized by what is presented in claim 1.

The seeding substrate of the invention is characterized by what is presented in claim 11.

In the method of the invention, the seeds are inoculated with a microbial population desired for the land area. The desired microbial population helps the seed sown as well as the seedling planted survive the critical phase of activation of growth. During a so called critical month, the seed or seedling is subjected to a great stress as it is adapting to its site of germination or growth.

In an embodiment of the method, the seeds are inoculated with a microbial population substantially corresponding to the microbial population in the future seeding site. Seeds infected with the microbes of its future habitat adapt quickly to the soil and are able to utilize the benefits resulting from the activity of soil microbes while avoiding possible allelopathy, among other things. In addition, the microbial population. can be used to modify the microbial population in the sowing area so that it will contain e.g. microbes beneficial to the plants.

In this context, the term ‘microbe’ as known in microbiology refers generally to any micro-organisms, e.g. bacteria, fungi, yeasts, algae, spores, protozoans, viruses, etc., that may be present in the sowing area. ‘Microbial population’ refers to individual cells, colonies, mycocelial filaments, e.g. in the case of root fungi to mycorrhiza, and so on.

To implement the inoculation, a microbial population suited for the plant species and area to be sown is used. The microbial population to be used for inoculation may comprise pieces of mycorrhiza and/or spores e.g. dissolved in a liquid, such as water, and/or included in biodegradable material, such as turf and humus. The occurrence of mycorrhiza infection is especially important, often even necessary for the plants. The mycorrhiza enhances the plant's ability to absorb nutrients, maintains its health, protects it against stress factors, improves soil structure: and reduces erosion and denudation.

In an embodiment of the method, the microbial population is determined from a sample taken from the seeding site and the microbial population to be used is selected on the basis of this determination. The microbe determination may comprise one or more microbe species selected from any species suitable for the target being studied, e.g. a species favorable for the plants. The microbe determination may be implemented by applying a practice generally known in microbiology, such as the practice of keeping the sample for a certain period in conditions permitting growth of the microbe/microbes in order to generate a possible population of the microbe and by determining the microbial growth.

In an embodiment of the method, the microbial growth determined from the sample is compared to a previously compiled model file containing descriptions of growth of a corresponding microbe/corresponding microbes using e.g. a means as presented in Finnish patent 100725, and the microbial population is selected on the basis of the results thus obtained.

To achieve a sufficient adaptation effect, the seeds are inoculated with the desired microbial population before being sown. Usually the seeds are inoculated at least 1 month before the sowing.

By this method, seeds of one or more different plant species can be sown simultaneously. By sowing seeds of different plant species, it is possible to accelerate the known succession development of wood. The seeds to be used are selected from seeds of conifers, broadleaf trees, twigs, graminids and/or corresponding plants, depending on the intended use. Seeds of twigs and graminids are used besides seeds of the dominating wood species to increase the diversity of land areas. In forest regeneration, seeds of conifers, such as spruce and/or pine, and in mixed forests additionally seeds of e.g. birch are normally used. Seeds of finewood trees can be used in broad-leaved forests. The seeds are preferably selected from seeds of symbiotic plants. In tropical land areas, seeds of e.g. rainforest trees and plants, e.g. eucalyptus, are used. Seeds of fast growing graminids, e.g. different sorts of hay, grass, willowherb etc. can be used in a controlled manner together with seeds of trees to protect the seedlings of trees. Seeds of broad-leaved trees growing faster than conifers, e.g. seeds of birch, alder, aspen, mountain ash, great sallow and so on, are also used to protect the seeds/seedlings of other trees and to prevent an excessive growth of graminids, to increase or vary diversity and to promote the health of the soil. By sowing seeds of different plant species, it is possible to avoid the use of plant protectants. Seeds of plants producing different nutrients can also be used to produce nutrients for the seeds/seedlings of other species, e.g. seeds/seedlings of alder can be used to produce nitrogen in the soil.

The seeds are sown either manually or mechanically using e.g. a harvester, a reaping machine and/or a seeding machine on a land area to be regenerated, restored, landscaped and/or on a corresponding land area. The seeds are sown in a forest area in connection with the felling and/or harvesting of wood, thus obviating the need for laborious and expensive regeneration afterwards. The seeds are preferably sown using a harvester. For regeneration or restoration of arable land or developed areas, usually a seeding machine is used.

In connection with felling and/or harvesting, it is possible to inoculate saw dust with the desired microbial population and spread the saw dust on the sowing area.. The sawdust produced in connection with the felling of trees is a sterile material and it is susceptible to factors such as bacteria and viruses causing diseases. By inoculating the saw dust with a desired microbial population, the saw dust is protected against harmful factors causing diseases while the desired microbial population in the sowing area is strengthened. The saw dust can be inoculated in connection with manual or mechanical felling and harvesting of wood.

The seeding substrate of the invention comprises a growth medium consisting. of biodegradable mass, said growth medium being provided with a desired microbial population to be applied to a land area to be regenerated restored and/or landscaped and with at least one seed placed in it

If desired, the seeds are placed in a seed layer in conjunction with the growth medium. The seed layer comprises at least one seed and a biodegradable seed substrate.

In an embodiment of the seeding substrate, the biodegradable growth medium is inoculated with the desired microbial population.

In an embodiment of the seeding substrate, the seed layer is inoculated with the desired microbial population.

The function of the growth medium is to protect the seed and to prevent the evaporation of moisture among other things. The. biodegradable growth medium consists of a material degradable in nature, e.g. vegetable material such as chemical pulp fiber, turf, humus and/or similar biodegradable material. The biodegradable substrate preferably consists of short-fibered and/or long-fibered chemical pulp containing about 60 w-% coniferous wood and about 40 w-% hardwood, such as birchwood.

If necessary, the growth medium may also contain nutrients, such as micronutrients and other nutritives needed by the seed/plant. In warm areas e.g. having no winter or in other areas where the soil contains plenty of microbes or vermin causing plant diseases, substances designed for their control and prevention, limitation and control of their proliferation can be added into the growth medium.

Growth mediums can be prepared in advance and stored. Thus, based on a determination of microbial population as described above, a growth medium inoculated with a desired microbial population can be selected from among the stored growth mediums.

The function of the seed substrate is to facilitate the disposition of seeds on the growth medium. A seed layer, which may be prepared in advance, is placed on a growth medium selected in accordance with the determination of microbial population. The biodegradable seed substrate consists of a material degradable in nature similar to the growth medium.

The seeds to be sown can be placed on the growth medium one or more at a time. The same growth medium may contain seeds of the same plant or of different plants according to their natural diversity as described above in connection with the method of the invention. The seeds may be placed on the growth medium either manually or mechanically by techniques known in the art, using e.g. a technique known from the band sowing method applied in the sowing of sugar beet.

A top layer may be placed over the growth medium and seed layer to protect the seeds from drought and/or cold. The top layer consists of material degradable in nature, e.g. vegetable material such as chemical pulp fiber and/or similar biodegradable material Usually the top layer consists of gauze made of short-fibered and/or long-fibered chemical pulp fiber, containing about 60 w-% coniferous wood and about 40w-% finewood, such as birchwood.

In an embodiment of: the seeding. substrate, the growth medium and the seed layer are provided with a top layer protecting the seed from drought and/or cold. The top layer preferably consists of gauze.

The seeding substrate may consist of an elongate band-like strip, which may be provided with perforations to allow easy severing of the strip and which can be delivered in rolls, or of a patch-like piece or substantially three-dimensional pieces, such as granular, pill-like, spherical and/or other bodies of regular or irregular shape.

The result of regeneration and restoration of land areas achieved by the method of the invention is natural and consistent with the objective regarding landscape.

A further advantage of the invention as compared with prior-art techniques is based on the adaptation of the seed to its new habitat and on facilitating germination, which accelerates the start of growth, improves germinability and reduces the amount of seeds needed.

Moreover, the invention makes it possible to sow the seeds in connection with the felling and harvesting of wood, thus saving labor, time as well as the land area.

In the following, the invention will be described in detail by the aid of a few examples of its embodiments with: reference to the attached drawing, wherein

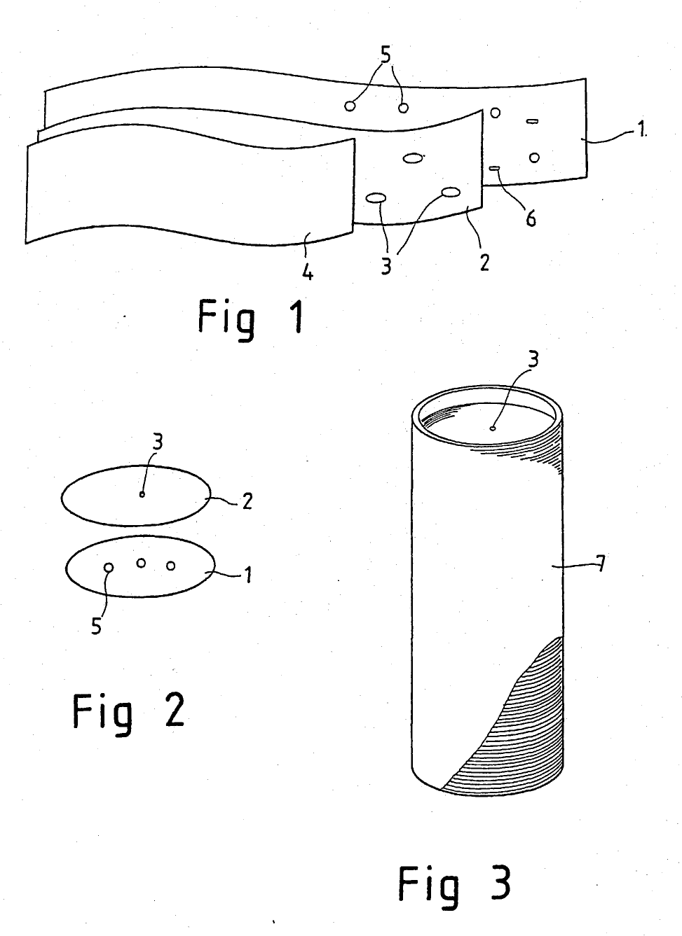

FIG. 1 presents an embodiment of the seeding substrate of the invention,

FIG. 2 presents another embodiment of the seeding substrate of the invention, and

FIG. 3 presents an embodiment of a means according to the invention.

FIG. 1 shows a partially band-like seeding substrate comprising a growth medium 1 consisting of biodegradable material, a seed layer 2 formed on top of the growth medium and containing seeds 3 of one or more plant species placed at a suitable distance from each other, and, formed on top of the seed layer 2, a top layer 4 consisting of biodegradable material, protecting the seeds from drought and cold. In the embodiment presented, the growth medium 1 contains a microbial population 5 substantially corresponding to the microbial population of the seeding site, as well as nutrients 6 needed by the plant.

FIG. 2 shows a patch-like seeding substrate comprising a growth medium 1 consisting of biodegradable material and a seed layer 2 formed on top of the growth medium and consisting of a seed layer forming one seed 3. In the embodiment presented, the growth medium 1 contains a microbial population 5 substantially corresponding to the microbial population of the seeding site.

FIG. 3 presents a cartridge 7, i.e. a cylindrical container which can be used to store and distribute seeding substrates as illustrated in FIG. 2. The cartridge can be installed e.g. on a harvester or other machine moving in the area being treated. By using a suitable gripping means, seed patches can be taken from the cartridge completely automatically and deposited in the soil. The seeds can be arranged in the cartridges in a suitable predetermined manner so that the various seeds to be sown are distributed over the sowing area as desired.

### EXAMPLE 1

In this example, a seeding substrate as illustrated in FIG. 1, intended for the regeneration of a pine forest, is prepared. The growth medium used is a band made of chemical pulp fiber, containing 60 w-% conifer and 40 w-% birch. The growth medium is provided with an addition of ectomycorrhiza, which. is typically encountered in coniferous woods and which, based on a determination, substantially corresponds to the microbial growth in the seeding site. The inoculation consists of spores of ectomycorrhiza in a water solution. Moreover, nutritive substances, such as principal nutrients: N, P, K, S, Ca, Mg, Fe; micronutrients: B, Mo, Mn, Co, Zn, Cu, Cl, I; carbohydrates, vitamins and, if desired, substances for the control of growth are added to the seeding substrate. Onto the growth medium, seeds of pine and a protective graminid, such as willow herb, are added using equipment generally used in the production of seeding strips. A top layer consisting of band-like gauze is placed on top of the seeding substrate and seed layer.

The seeds are sown using e.g. a harvester in connection with final cutting. From the band-like seeding substrate, the harvester cuts pieces of a suitable size containing a seed of pine and a graminid and sows them in desired places at a suitable distance from each other.

The band-like seeding substrate can also be stored for later use.

### EXAMPLE 2

In this example, a seeding substrate as. illustrated in FIG. 2, intended for a wet spruce forest regeneration area, is prepared. The growth medium used consists of turf in patch-like form. The microbial population to be used is selected by determining the microbial population from a sample taken from the seeding site, by comparing it to model files containing descriptions of growth of corresponding microbes, using a means as described in Finnish patent 100725. The microbial population selected is added to the growth medium in the form of pieces of mycorrhiza.

A seeding substrate for a spruce seed is prepared by placing a seed obtained from a parent tree on the growth medium, and the seeding substrate is sown in the regeneration area.

A seeding substrate intended for a land area to be restored, e.g. a land area polluted with chemicals, can be prepared in the same way.

When desirable, seeding substrates as described above can be produced by using alder seeds instead of spruce seeds. Thus, seeding substrates containing spruce seeds and seeding substrates containing alder seeds can be sown in suitable proportions in the area to be regenerated. Being a fast growing species, alder prevents excessive growth of graminids and protects and shades the spruce seedling, causing the latter to grow straight upward. In addition, alder produces nitrogen in the soil.

### EXAMPLE 3

In this example, spruce, alder and willowherb seeds are sown in a spruce wood regeneration area. The sowing is performed in connection with wood harvesting using a harvester with a cartridge as presented in FIG. 3 placed in its rear part. The cartridge is provided with seeding substrates provided with growth mediums with spruce, alder and willowherb seeds in proportions of 10:3:5, prepared as specified in example 2. The harvester sows the seeds in the desired proportions, the spruce seedling being protected by the fast growing alder and willowherb.

When desirable, the harvester can be provided with several cartridges in which the proportions of growth mediums containing seeds of different plants, the seeds used and/or the microbial population used are different and which is/are used when the nitrogen or seeding scheme for the land area being regenerated changes.

In addition, the harvester can be provided with a container from which a desired microbial population can be applied to the saw dust produced in sawing to strengthen. a selected microbial population in the sowing area.

The invention is not restricted to the examples of its embodiments described above; instead, many variations are possible within the scope of the inventive idea defined in the claims.

1. Method for the sowing of seeds, in which method the seeds are inoculated with a desired microbial population, characterized in that the seeds are inoculated with a microbial population intended for a land area to be regenerated, restored and/or landscaped and the inoculated seeds are sown on said land area.

2. Method as defined in claim 1, characterized in that the desired microbial population substantially corresponds to the microbial population of the future seeding site of the seeds.

3. Method as defined in any one of claims 1-2, characterized in that the microbial population is determined from the future sowing area of the seeds and the microbial population to be used is selected on the basis of this determination.

4. Method as defined in any one of claims 1-3, characterized in that the microbial population is determined from a sample taken from the seeding site and it is compared to a previously compiled model file containing descriptions of growth of a corresponding microbe and, based on the results obtained, a microbial population substantially corresponding to the microbial population of the seeding site is selected.

5. Method as defined in any one of claims 1-4, characterized in that the seeds are sown after the inoculated microbial population has produced a sufficient effect.

6. Method as defined in any one of claims 1-5, characterized in that seeds of one or more plant species are sown.

7. Method as defined in any one of claims 1-6, characterized in that the seeds are sown manually and/or mechanically using e.g. a harvester, a reaping machine and/or a seeding machine.

8. Method as defined in any one of claims 1-7, characterized in that seeds inoculated with microbial populations selected from the, seeding site on the basis of said determination are sown mechanically.

9. Method as defined in any one of claims 1-8, characterized in that the seeds are sown in connection with felling and/or harvesting of wood.

10. Method as defined in any one of claims 1-9, characterized in that saw dust is inoculated with a desired microbial population and the inoculated saw dust is spread on the sowing area.

11. Seeding, substrate for the sowing of seeds, characterized in that the seeding substrate comprises a growth medium of biodegradable material, said growth medium being provided with a desired microbial population to be applied to a land area to be regenerated restored and/or landscaped and with at least one seed placed in it.

12. Seeding substrate as. defined in claim 11, characterized in that the seeds are placed in a seed layer in conjunction with the growth medium.

13. Seeding substrate as defined in claim 11 or 12, characterized in that the growth medium has been inoculated with a desired microbial population.

14. Seeding substrate as defined in claim 11 or 12, characterized in that the; seed layer has been inoculated with a desired. microbial population.

15. Seeding substrate as defined in any one of claims 11-14, characterized in that the biodegradable growth medium contains nutrients and/or substances intended for fighting infectious plant diseases and vermin.

16. Seeding substrate as defined in any one of claims 11-15, characterized in that the seeding substrate is provided with at least one seed of a different plant species.

17. Seeding substrate as defined in any one of claims 11-16, characterized in that the seeding substrate is provided with at least one seed of a tree and at least one seed of a graminid protecting it.

18. Seeding substrate as defined in any one of claims 11-17, characterized in that the seeding substrate comprises a protective layer placed upon the seed layer.

19. Seeding substrate as defined in any one of claims 11-18, characterized in that the seeding substrate consists of an elongate band-like strip.

20. Seeding substrate as defined in any one of claims 11-18, characterized in that the seeding substrate consists of a patch-like piece.

21. Seeding substrate as defined in any one of claims 11-18, characterized in that the seeding substrate consists of substantially three-dimensional pieces, such as granular, pill-like, spherical and/or other bodies of regular or irregular shape.
